(19) United States
(12) Patent Application Publication
(10) Pub. No.: US 2022/0219707 A1
(43) Pub. Date: Jul. 14, 2022

(54) VEHICLE CONTROL ASSEMBLY FOR AUTOMATICALLY CONTROLLING AT LEAST ONE VEHICLE, AND METHOD FOR CONTROLLING SAME

(71) Applicant: FRABA B.V., SG HEERLEN (NL)

(72) Inventors: CHRISTIAN LEESER, DUESSELDORF (DE); MARTIN FORTHAUS, KOELN (DE)

(73) Assignee: FRABA B.V., SG HEERLEN (NL)

(21) Appl. No.: 17/614,568

(22) PCT Filed: May 18, 2020
(86) PCT No.: PCT/EP2020/063802

§ 371 Date: Nov. 29, 2021

(30) Foreign Application Priority Data
May 31, 2019 (DE) 10 2019 114 673.9

(51) Int. Cl. B60W 40/105; B60W 40/12

(52) U.S. Cl. CPC B60W 40/105; B60W 40/12; B60W 2510/18; B60W 2420/52; B60W 2420/42

(57) ABSTRACT

A vehicle control assembly for an automatic control of a vehicle in an enclosed spatial field. The enclosed special field includes objects and floor area portions. The vehicle includes a drive device and a vehicle control device which controls the vehicle. The vehicle control assembly includes a navigation system for determining a position of the vehicle in the enclosed spatial field, a room sensor system with at least one 3D sensor assembly which is arranged in the enclosed spatial field, and a room control unit to which each of the room sensor system and the vehicle control device are controllably connected. The room sensor system detects a predeterminable size of each of the vehicle, each of the objects, and each person, respectively. The room control unit associates an at least two-dimensional safety region with the vehicle, with each of the objects, and with each person.

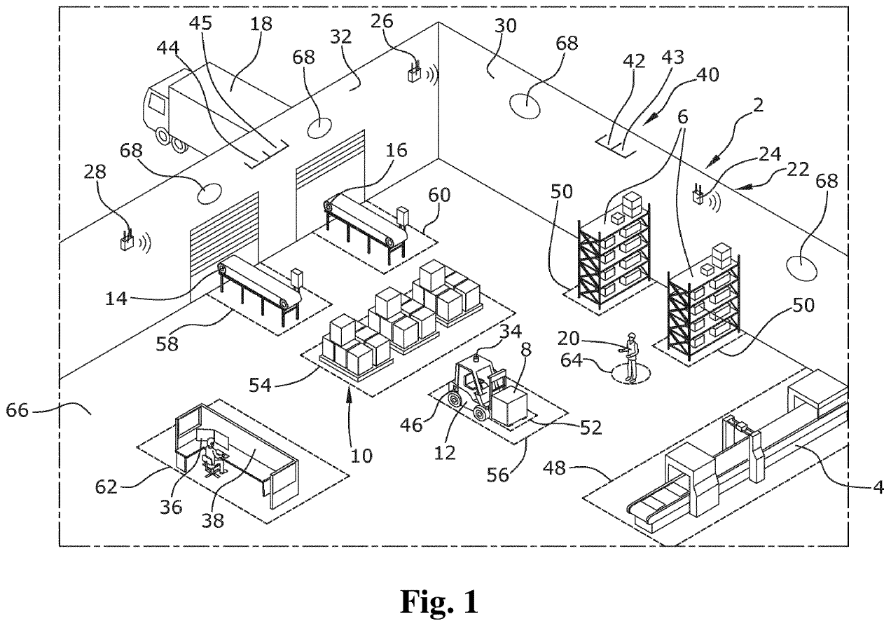

### CROSS REFERENCE TO PRIOR APPLICATIONS

This application is a U.S. National Phase application under 35 U.S.C. § 371 of International Application No. PCT/EP2020/063802, filed on May 18, 2020 and which claims benefit to German Patent Application No. 10 2019 114 673.9, filed on May 31, 2019. The International Application was published in German on Dec. 3, 2020 as WO 2020/239493 A1 under PCT Article 21(2).

### FIELD

The present invention relates to a vehicle control assembly for the automatic control of at least one vehicle having a drive device, in an enclosed spatial field with a number of objects, wherein the enclosed spatial field comprises at least floor area portions, wherein a navigation system for determining the position of the at least one vehicle is provided in the enclosed spatial field, wherein the vehicle comprises a vehicle control device for controlling the vehicle. The present invention also relates to a method for controlling at least one vehicle having such a vehicle control assembly.

### BACKGROUND

The prior art describes automatically control and autonomously move vehicles, for example, floor conveyor vehicles, in a space, such as a factory hall. Induction loops can be inserted in the floor area portions, for example, for moving a vehicle from A to B on a specific path. The vehicle can also comprise a plurality of sensors for preventing the vehicle from colliding with objects which can be persons as well as parts of cabinets, parts of goods etc. Prior art vehicle control assemblies have also been described where the vehicle comprises a complex on-board sensor system which enables the vehicle to safely and freely move in the respective space.

It should be appreciated that both arranging induction loops in floor area portions and equipping each vehicle with a complex on-board sensor system is expensive and complicated.

### SUMMARY

An aspect of the present invention is to eliminate the aforementioned drawbacks.

In an embodiment, the present invention provides a vehicle control assembly for an automatic control of at least one vehicle in at least one enclosed spatial field. The at least one enclosed special field comprises a plurality of objects and floor area portions. The at least one vehicle comprises a drive device and a vehicle control device which is configured to control the at least one vehicle. The vehicle control assembly includes a navigation system for determining a position of the at least one vehicle in the at least one enclosed spatial field, a room sensor system comprising at least one 3D sensor assembly which is arranged in the at least one enclosed spatial field, and a room control unit to which each of the room sensor system and the vehicle control device are controllably connected. The room sensor system is configured to detect a predeterminable size of each of the at least one vehicle, each of the plurality of objects, and each person, respectively. The room control unit is configured to associate an at least two-dimensional safety region with the at least one vehicle, with each of the plurality of objects, and with each person.

### BRIEF DESCRIPTION OF THE DRAWING

The present invention is described in greater detail below on the basis of embodiments and of the drawing in which:

The FIGURE shows a schematic perspective view of an enclosed spatial field in the form of a factory hall.

### DETAILED DESCRIPTION

The present invention provides that in the enclosed spatial field, a room sensor system having at least one 3D sensor assembly is provided, wherein the room sensor system and the vehicle control device are controllably connected to a room control unit, wherein the vehicle and each object, respectively, having at least a predeterminable size, can be detected by the sensor system, and wherein the room control unit associates an at least two-dimensional safety region with the vehicle, each object and each person. It is thereby possible in a simple manner to move a vehicle through the room without any complex on-board sensor system for controlling the vehicle. When an overlap of safety distances is detected, the room control unit can control the vehicle with regard to movement velocity and movement direction so that a path is selected which is not occupied by a safety region of an object. Even persons can be provided with a safety region by the room control unit so that accidents can be avoided. The vehicles can have a very simple sensor system due to the vehicle control unit. New vehicles also need not be adapted to a sensor system. The vehicle control assembly according to the present invention can also be flexibly adapted to changes in the room.

For a safe control of in particular ground vehicles, it is advantageous when the two-dimensional safety region is configured as a projection of the respective object and person, respectively, to the floor area portion.

According to a particularly advantageous embodiment, the navigation system can, for example, be configured as a distance measuring system, for example, as a GPS system etc., comprising at least two satellite components and a receiver component arranged at the vehicle, wherein the receiver component is controllably connected to the vehicle control device. Such a distance measuring system provides a very exact determination of the position of the vehicle. It should be appreciated that the number of satellite components also in particular depends on the 3D sensor assembly.

A 3D sensor assembly is advantageously configured as a ToF sensor or a radar sensor. At least one camera can here be associated with the 3D sensor assembly. This provides a diversity of the vehicle control assembly, however, an additional security function can also be provided, for example, for increasing burglar prevention.

Light sources for completely illuminating the room can be provided in the enclosed spatial field to enable a complete resolution of the objects for the room control unit, in particular via the camera.

It can in particular be advantageous for floor conveyor vehicles when the vehicle comprises at least one sensor for fine positioning, such as, for example, a distance sensor. A particularly advantageous embodiment of a vehicle control assembly according to the present invention is provided when in the room control unit at least one reference map of the enclosed spatial field with positions of non-movable objects and the associated safety regions is provided. The control effort can thereby be considerably reduced.

The present invention is further realized by a method for controlling at least one vehicle having such a vehicle control assembly, wherein, in a first step, the enclosed spatial field is detected by the room sensor system, in a second step, a safety region is associated with all objects and the at least one vehicle by the room control unit, in a third step, the drive device of the vehicle is started, and in a fourth step, the vehicle is purposefully driven or braked on the basis of parameters to be defined by the room control unit, such as location, movement direction, velocity, acceleration and acceleration direction.

The present invention will be explained in detail under reference to the drawing which shows a schematic perspective view of an enclosed spatial field in the form of a factory hall.

An enclosed spatial field can be understood as both enclosed rooms and delimited free fields, such as, for example, an airfield.

The schematically illustrated factory hall 2 conventionally comprises a production facility 4 and storage racks 6 whose stock is required for the production of a product 8 on the production facility. After production of the product 8, the product 8 is transferred to a storage area 10 with the aid of a floor conveyor vehicle 12. In the storage area 10, the products 8 can be loaded onto a truck 18 via loading stations 14, 16. In the factory hall 2, persons 20 can also be present for operating the production facility 4. A conventional navigation system 22 for determining the position of the floor conveyor vehicle 12 in the factory hall 2 is provided for autonomously and safely moving the floor conveyor vehicle 12 in the factory hall 2. The conventional navigation system 22 is here configured as a GPS system comprising three satellite components 24, 26, 28 fastened to side walls 30, 32. The floor conveyor vehicle 12 conventionally comprises a receiver component 34. The conventional navigation system 22 is controllably connected to a room control unit 36 which is here schematically shown as an operating station 38. For safely moving the vehicle in the factory hall 2 without harming any objects or persons 20, a room sensor system 40 is provided which, in the present case, comprises two 3D sensor assemblies 42, 44. These 3D sensor assemblies 42, 44 are here configured as so-called ToF sensors (time-of-flight sensors), wherein a camera 43, 45 in the form of a video camera is associated with each ToF sensor 42, 44. This room sensor system 40 is also controllably connected to the room control unit 36. The floor conveyor vehicle 12 also comprises a vehicle control device 46 which is also controllably connected to the room control unit 36 and controlled thereby. The present invention provides that the room control unit 36 associates a safety region 48, 50, 52, 54, 56, 58, 60, 62, 64 with each object 4, 6, 8, 10, 12, 14, 16, 38 and each person 20, respectively, which safety region, in the present exemplary embodiment is configured as a two-dimensional safety region 48, 50, 52, 56, 58, 60, 62, 64 as a projection of the respective object 4, 6, 8, 10, 12, 14, 16, 38 or the respective person 20 to a floor area portion 66 of the factory hall 2. Light sources 68 for completely illuminating the factory hall 2 are also provided.

The method for controlling the floor conveyor vehicle 12 provides that, in a first step, the room in the form of a factory hall 2 is detected by the room sensor system 40. In a second step, a safety region 48, 50, 52, 54, 56, 58, 60, 62, 64 is associated with all objects 4, 6, 8, 10, 12, 14, 16, 38, including the persons 20 and the at least one floor conveyor vehicle 12, by the room control unit 36. In a subsequent third step, a drive device (which is not shown in the drawing) of the floor conveyor vehicle 12 can be started to, in a fourth step, purposefully drive or brake the floor conveyor vehicle 12 on the basis of parameters to be defined by the room control unit 36, such as movement direction and movement velocity.

A reference map of the non-movable objects 4, 6, 14, 16, 38 can be provided in the room control unit 36 to reduce the control effort.

The present invention is not limited to embodiments described herein; reference should be had to the appended claims.

### LIST OF REFERENCE NUMERALS

2 Factory hall
4 Production facility
6 Storage rack
8 Product
10 Storage area
12 Floor conveyor vehicle
14 Loading station
16 Loading station
18 Truck
20 Person
22 Conventional navigation system
24 Satellite component
26 Satellite component
28 Satellite component
30 Side wall
32 Side wall
34 Receiver component
36 Room control unit
38 Operating station
40 Room sensor system
42 3D sensor assembly/TOF sensor
43 Camera
44 3D sensor assembly/TOF sensor
45 Camera
46 Vehicle control device
48 Safety region
50 Safety region
52 Safety region
54 Safety region
56 Safety region
58 Safety region
60 Safety region
62 Safety region
64 Safety region
66 Floor area portion
68 Light source

What is claimed is:

1-9. (canceled)

10: A vehicle control assembly for an automatic control of at least one vehicle in at least one enclosed spatial field,
wherein,
the at least one enclosed special field comprises a plurality of objects and floor area portions, and
the at least one vehicle comprises a drive device and a vehicle control device which is configured to control the at least one vehicle,
the vehicle control assembly comprising:
a navigation system for determining a position of the at least one vehicle in the at least one enclosed spatial field;
a room sensor system comprising at least one 3D sensor assembly which is arranged in the at least one enclosed spatial field, the room sensor system being configured to detect a predeterminable size of each of the at least one vehicle, each of the plurality of objects, and each person, respectively; and
a room control unit to which each of the room sensor system and the vehicle control device are controllably connected, the room control unit being configured to associate an at least two-dimensional safety region with the at least one vehicle, with each of the plurality of objects, and with each person.

11: The vehicle control assembly as recited in claim 10, wherein the at least two-dimensional safety region is configured as a respective projection of the plurality of objects and person to the floor area portions.

12: The vehicle control assembly as recited in claim 10, wherein,
the navigation system is configured as a distance measuring system which comprises at least two satellite components and a receiver component arranged at the at least one vehicle, and
the receiver component is controllably connected to the vehicle control device.

13: The vehicle control assembly as recited in claim 12, wherein the distance measuring system is a GPS system.

14: The vehicle control unit as recited in claim 10, wherein the at least one 3D sensor assembly is configured as a ToF sensor or as a radar sensor.

15: The vehicle control unit as recited in claim 10, further comprising:
at least one camera which is associated with the at least one 3D sensor assembly.

16: The vehicle control unit as recited in claim 10, further comprising:
light sources which are arranged in and which are configured to completely illuminate the at least one enclosed spatial field.

17: The vehicle control unit as recited in claim 10, wherein the at least one vehicle further comprises at least one sensor for a fine positioning.

18: The vehicle control unit as recited in claim 17, wherein the at least one sensor for the fine positioning is a distance sensor.

19: The vehicle control unit as recited in claim 10, wherein the room control unit is provided with at least one reference map of the at least one enclosed spatial field with positions of the plurality of objects which are non-movable and of the at least two-dimensional safety region associated therewith.

20: A method for controlling at least one vehicle comprising the vehicle control assembly as recited in claim 10, the method comprising:
detecting the at least one enclosed spatial field via the room sensor system;
associating, via the room control unit, a respective at least two-dimensional safety region with the at least one vehicle, with each of the plurality of objects, and with each person;
staring the drive device of the at least one vehicle; and
purposefully driving or braking the at least one vehicle based on parameters to be defined by the room control unit.

21: The method for controlling the at least one vehicle as recited in claim 20, wherein the parameters to be defined by the room control unit include a location, a movement direction, a velocity, an acceleration, and an acceleration direction.
